(19) United States
(12) Patent Application Publication
(10) Pub. No.: US 2004/0068340 A1
(43) Pub. Date: Apr. 8, 2004

(54) Method of providing improved performance of software tools

(76) Inventor: Thomas Mayberry, Holliston, MA (US)

Correspondence Address: DALY, CROWLEY & MOFFORD, LLP, SUITE 101, 275 TURNPIKE STREET, CANTON, MA, 02021-2310, US

(21) Appl. No.: 10/665,707

(22) Filed: Sep. 18, 2003

Related U.S. Application Data
(60) Provisional application No. 60/415,715, filed on Oct. 3, 2002.

(51) Int. Cl. G06F 19/00

(52) U.S. Cl. 700/108

(57) ABSTRACT

A method and computer program product for providing improved performance for software tools is presented. The method includes the steps of accumulating data during execution of the tool, examining the data, formulating recommendations on how to achieve better performance for the tool and applying the changes to the tool. The computer program product includes instructions for accumulating data during execution of the tool, examining the data, formulating recommendations on how to achieve better performance for the tool and applying the changes to the tool.

### CROSS REFERENCE TO RELATED APPLICATIONS

This application claims priority under 35 U.S.C. §119 (e) to provisional application serial No. 60/415,715 filed Oct. 3, 2002, the disclosure of which is hereby incorporated by reference.

### STATEMENT REGARDING FEDERALLY SPONSORED RESEARCH

Not Applicable.

### FIELD OF THE INVENTION

The present invention relates generally to software tools and more particularly to a method and computer program product for examining data accumulated while using a software tool and making recommendations on achieving improved performance from the software tool.

### BACKGROUND OF THE INVENTION

Software tools are well known in the art. Most software tools contain various options or settings that allow a user of the tool to customize the behavior of the tool in order to provide increased performance. When the tool is not performing as desired, then these settings can be adjusted as required. A problem arises in knowing which software tool settings should be manipulated in order to obtain improved performance of the tool. These software tools typically have dozens (and potentially hundreds) of these options, most of which are rarely used. In order to locate the settings of interest, the user is often required to have extensive knowledge and experience with the given software tool. Alternately, the user may have to spend a significant amount of time experimenting with different tool settings until an optimal combination is found. A current solution is to rely on a person who is both knowledgeable about the application being addressed by the software tool and is further knowledgeable about the tool being used to test the application. This knowledge often comes with years of experience. This person typically is either an experienced customer or an experienced support engineer.

### SUMMARY OF THE INVENTION

A method of providing improved performance for software tools is presented. The method includes the steps of accumulating data during execution of the tool, examining the data, formulating recommendations on how to achieve better performance for the tool and applying the changes to the tool.

A computer program product for providing improved performance for software tools is presented. The computer program product includes instructions for accumulating data during execution of the tool, examining the data, formulating recommendations on how to achieve better performance for the tool and applying the changes to the tool.

### BRIEF DESCRIPTION OF THE DRAWINGS

The invention will be more fully understood from the following detailed description taken in conjunction with the accompanying drawings, in which:

FIG. 1 is a flow chart of the present method; and

FIG. 2 is a block diagram of an environment using the present computer program product.

### DETAILED DESCRIPTION OF THE INVENTION

A method and computer program product for providing improved performance of software tools is presented. The method and computer program product incorporates a rule-based system that examines data accumulated during the execution of a tool and (if possible) makes recommendations on how to customize the tool settings in order to improve performance of the tool. In addition, the method and computer program product may automatically apply the recommended settings so as to automatically solve a particular issue. For example, if a tool were to print out a document that was improperly oriented, the present method and computer program product could either recommend that the orientation be changed from portrait to landscape, or the present invention could automatically make the change before printing the document. In a typical scenario the present invention would be making recommendations based on the various issues encountered by the user of the tool.

One advantage provided by the present invention is that users at all levels of experience and skill can perform complex tool customizations by simply following the recommendations provided by the present method and computer program product. This saves time for both customers of the software tool and for the support and development engineers associated with the tool.

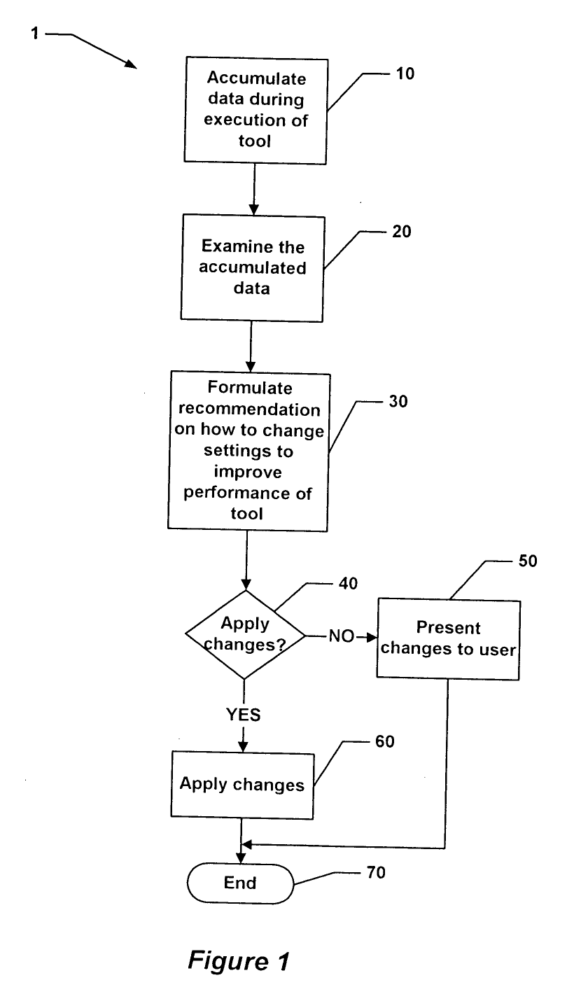

A flow chart of the presently disclosed method is depicted in FIG. 1. The rectangular elements are herein denoted “processing blocks” and represent computer software instructions or groups of instructions. The diamond shaped elements, are herein denoted “decision blocks,” represent computer software instructions, or groups of instructions which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 1 the present method of providing improved performance for software tools is shown. The first step of the method is step 10 wherein data is accumulated during execution of the tool. During the execution of the software tool, data is collected from a variety of sources and is used by a “Troubleshooter” (a processor executing a rule set). This data includes such things as events received from a browser, buttons the user may have pushed or clicked, internal errors that may have occurred, various discoveries made from parsing the JavaScript of a page, information about parameters for each request, and the like.

Step 20 is executed next wherein the accumulated data is examined. A rule-based system may be used to examine the data.

Following step 20, step 30 is performed wherein recommendations on how to achieve better performance for the tool by changing various settings are produced. If a rule evaluates to TRUE, a description of the problem and a recommended solution are provided to the user.

At step 40 a decision is made as to whether the changes should be applied automatically to the tool. When the decision is not to automatically apply the recommended changes, then step 50 is executed wherein the recommended changes to the tool settings are presented to the user, and the user can decide whether to implement the changes or not. The process is then finished as shown at step 70.

When the decision in step 40 is to automatically apply the recommended changes, then step 60 is executed wherein the changes are automatically applied to the tool without user intervention. Following this step the process is finished, as shown at step 70.

In a particular example, the software tool being used is e-Tester™ available from Empirix Inc. of Waltham, Mass. e-tester is used for providing automated functional and regression testing for Web applications. e-Tester records all the objects on every web page visited and automatically inserts test cases to validate the objects.

As described above, the data accumulated by the present invention is examined in order to formulate recommended changes to various settings of the software tool being used. In a preferred embodiment, a rule-based system is used to examine the accumulated data.

One of the rules in the rule-based system could be:

RULE: if (playback failed OR playback was stopped by the user) AND (the browser generated a navigation complete event) AND (the browser did NOT generate a document complete event) then notify user.

e-tester has an Internet Explorer browser integrated therein. The version of Internet Explorer browser that e-Tester uses is the same as the version of the Internet browser that is installed on the machine. During recording and playback of a script, e-Tester monitors the signals and events from the browser so that it can perform its various tasks. One of these events is known as “Navigation Complete” and occurs once all of the page content has been downloaded. Another event is known as “Document Complete” which occurs once this content has been processed and rendered by the browser. During record and playback, e-Tester will look for the “Document Complete” event to determine if the page is complete. In some cases, with certain versions of Internet Explorer, the “Document Complete” event is never supplied by the browser. In these cases, e-Tester will continue to wait for completion until e-Tester finally reaches its timeout limit. However, e-Tester has the ability to terminate the recording or playback of a page by looking for the “Navigate Complete” event instead of the “Document Complete” event. In most cases, the use of “Navigation Complete” will work just as well as the use of “Document Complete”.

The solution for this problem comprises the following steps. The first step is to generate a new script. Due to certain complexities in the way an e-tester script is recorded, this setting must be applied both at record and playback time for it to work. In an alternate embodiment the old script may be reused. The next step is to set the SnapOnNavComplete=True switch setting in the Advanced Settings Manager of the e-Tester software tool. Then the test script is rerecorded with this switch setting in effect. Finally, the script is played back again to verify that the recommended change actually worked.

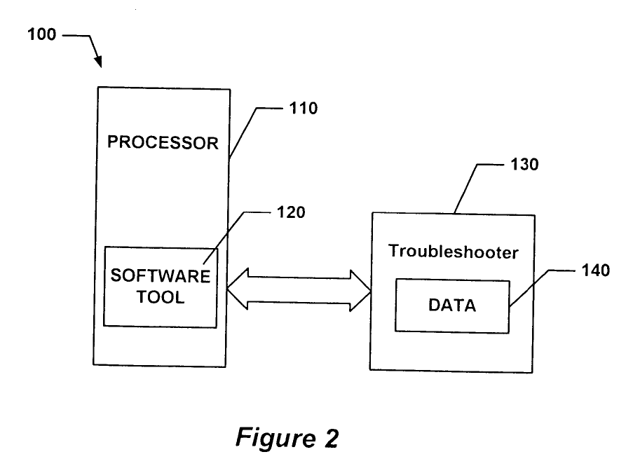

A software product for providing improved performance of software tools is also presented. The computer program product comprises instructions executable by a processor for performing various functions. Referring now to FIG. 2, an environment 100 showing the computer program product 130 is shown. The environment includes a processor 110 and a software tool 120. The computer program product (“Troubleshooter”) 130 is shown in communication with the software tool. The Troubleshooter collects data 140 from the executing software tool and formulates recommend changes to the setting s of the software tool 120 to allow for improved performance of the tool.

A first set of instructions of the computer program product comprises instructions for accumulating data during execution of the software tool. Depending on the tool being used, the data can include such things as events received from a browser, buttons the user may have pushed or clicked, internal errors that may have occurred, various discoveries made from parsing the JavaScript of a page, information about parameters for each request and the like.

A next set of instructions of the computer program product comprises instructions for examining the accumulated data. A rule-based system may be used to examine the data.

A next set of instructions of the computer program product comprises instructions for providing recommendations on how to achieve better performance for the tool. This may include changing various settings of the tool. If a rule evaluates to TRUE, a description of the problem and a recommended solution are provided to the user.

Another set of instructions of the computer program product comprises instructions for determining whether the changes to the tool settings should be applied automatically to the tool. When the decision is not to automatically apply the recommended changes, then the recommended changes to the tool settings are presented to the user, and the user can decide whether to implement the changes or not. Alternately, when the determination is to automatically apply the recommended changes, then the changes are automatically applied to the tool without user intervention.

A method and computer program product for providing improved performance for software tools has been presented. The method includes the steps of accumulating data during execution of the tool, examining the data, formulating recommendations on how to achieve better performance for the tool and applying the changes to the tool. The computer program product includes instructions for accumulating data during execution of the tool, examining the data, formulating recommendations on how to achieve better performance for the tool and applying the changes to the tool.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims. All publications and references cited herein are expressly incorporated herein by reference in their entirety.

What is claimed is:

1. A method of providing improved performance for a software tool comprising:
accumulating data during execution of the tool;
examining the data; and
formulating recommendations on how to achieve better performance for the tool.

2. The method of claim 1 further comprising applying the recommendations to the tool.

3. The method of claim 1 further comprising presenting the recommendations to a user of the tool.

4. The method of claim 1 wherein said accumulating data comprises accumulating at least one of the group consisting of events received from a browser, buttons the user pushed or clicked, internal errors that occurred, parsing the JavaScript of a page, and information about parameters for each request.

5. The method of claim 1 wherein said examining the data comprises applying a rule set to said data.

6. A computer program product comprising a computer usable medium having computer readable code thereon for providing improved performance for software tools comprising:
instructions for accumulating data during execution of the tool;
instructions for examining the data; and
instructions for formulating recommendations on how to achieve better performance for the tool

7. The computer program product of claim 6 further comprising instructions for applying the recommendations to the tool.

8. The computer program product of claim 6 further comprising instructions for presenting the recommendations to a user of the tool.

9. The computer program product of claim 6 wherein said instructions for accumulating data comprises instructions for accumulating at least one of the group consisting of events received from a browser, buttons the user pushed or clicked, internal errors that occurred, parsing the JavaScript of a page, and information about parameters for each request.

10. The computer program product of claim 6 wherein said instructions for examining the data comprises instructions for applying a rule set to said data.
